(19) United States
(12) Patent Application Publication
(10) Pub. No.: US 2004/0031539 A1
(43) Pub. Date: Feb. 19, 2004

(54) Decorative cooking oil container with disposable oil reservoirs

(76) Inventor: Jonathan Mark Goodwin, Tehachapi, CA (US)

Correspondence Address: Jonathan M. Goodwin, 22920 Monroe Ln., Tehachapi, CA, 93561, US

(21) Appl. No.: 10/217,587

(22) Filed: Aug. 13, 2002

(51) Int. Cl. B65B 3/04; B67C 3/02; B65B 1/04

(52) U.S. Cl. 141/98

(57) ABSTRACT

A cooking oil disposal container with disposable oil cylinder or alternative disposable cartridge. This system includes a container with a funnel shaped lid and a ball funnel cover. The oil disposal system has a cylinder bad with a cylinder rest attached to one end to prevent the cylinder bag from falling into the container. As an alternative, the disposable cartridge is a thermal cardboard cartridge that can be used in place of the cylinder bag. This is a matter of preference. Both the oil cylinder bag and alternative disposable cartridge are heat resistant and can withstand temperatures of up to 400 degrees Fahrenheit. Once full, the cylinder bag or alternative disposable cartridge can easily be removed and disposed of

The purpose of the invention is to provide a sanitary way to discard used cooking oil or fat.

### FIELD OF INVENTION

The present invention related to the culinary arts and particularly to the sanitary storage and removal of oil and fats.

### BACKGROUND OF INVENTION

Most household kitchens has the unpleasant task of trying to figure out what to do with excess fat or cooking oil after cooking their meals. The problem is you can't just pour it down the sink or it may cause plumbing and septic problems. As a result, most people have a coffee can under their kitchen sink or a cup on their kitchen counter full of discarded oils and fats. This option is neither sanitary nor aesthetically pleasing. It not only attracts unwanted pests and insects, it also creates a serious health hazard. Therefore, there exists a need for a sanitary method of storing and disposing of this household waste without creating an eyesore in the kitchen.

### SUMMARY

Decorative cooking oil container with disposable oil reservoirs. This provides an aesthetically pleasing alternative to storing and discarding used cooking oils and fats while limiting the potential for health risks. Its advantages provide an alternative to using a coffee can for the storage of said contents.

### BRIEF DESCRIPTION OF DRAWING

FIG. 1A Container Body

FIG. 1B Cylinder Rest Stop

FIG. 1C Funnel Container Lid

FIG. 1D Funnel Cover Ball

FIG. 2A Cylinder Rest

FIG. 2B Cylinder Bag

FIG. 2C Alternative Disposable Cartridge

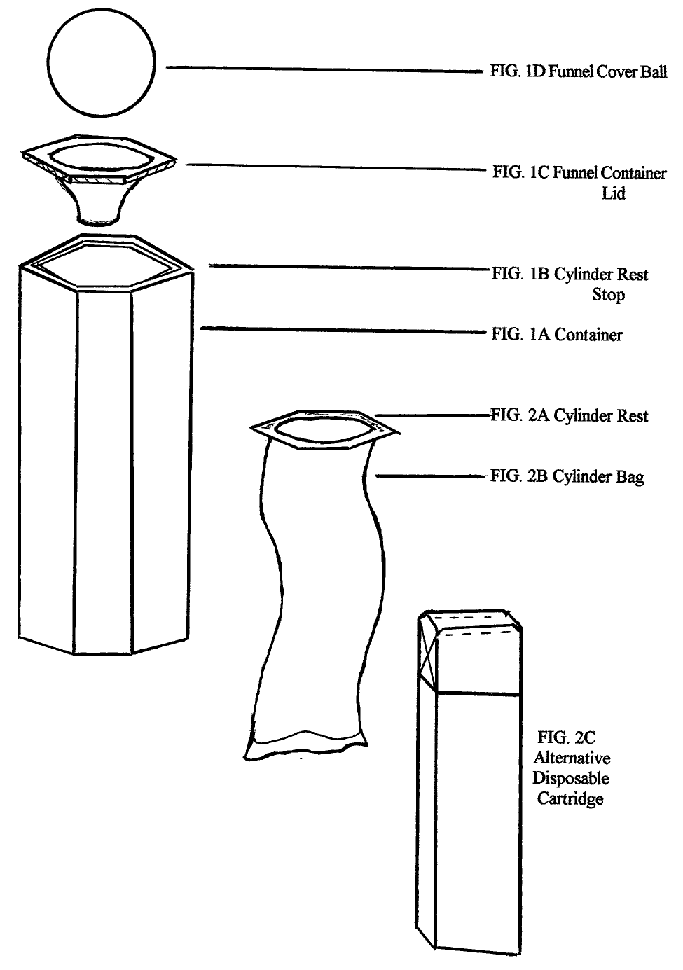

### DETAILED DESCRIPTION OF THE INVENTION

All parts of the said invention can be engineered utilizing technology and materials currently available. The decorative container, cylinder rest, funnel container lid, and funnel cover ball would be engineered and molded from one of three practical materials. Glass, ceramic, or plastic would be ideal for this process. The cylinder bag and cylinder rest would be constructed from plastic or a combination of plastic and cardboard. The alternative disposable cartridge would be made from cardboard.

In practical application, the disposable cylinder bag will be placed inside of the container. The funnel container lid will then be placed on top of the decorative container with the funnel portion down. The funnel cover ball will then be placed in the funnel portion of the container lid. Upon completion of frying oily foods, the culinary cook would simply remove the funnel cover ball and pour the unwanted oil down the funnel portion of the container lid and into the disposable cylinder bag. Once full, the cylinder bag would then be removed and disposed of accordingly.

The design has six main components with six separate functions as listed in order of operation.

The decorative container body must be large enough to contain desired amount of liquid.

The cylinder rest stop is located 1/8″ from the top inside the decorative container. It is a lip designed to prevent the cylinder rest and cylinder bag from falling into the container. It is an integrated part of the container itself

The funnel container lid rests firmly on top of the container with the funnel portion being placed inside of the disposable cylinder bag or alternative cardboard cartridge. Its design is to ensure hot liquids are poured direction into the cylinder bag or alternative cartridge without causing spillage.

The funnel cover ball is placed on top of the funnel container lid. The funnel cover ball prevents insects and debris from entering the container and foul odors from exiting the container.

The cylinder rest is placed inside of container on cylinder rest stop. The cylinder rest prevents the cylinder bag from falling into the container. The cylinder rest is an integrated part of the cylinder bag.

The cylinder bag and cylinder rest are considered to be one cylinder. Attached to the cylinder rest, the cylinder bag will hold discarded hot liquids of up to 400 degrees Fahrenheit. The cylinder bag is made from thermal heat resistant plastic.

As an alternative to the cylinder bag, a disposable thermal cardboard cartridge will slide firmly into the container. Once the cartridge is full, the to of the cartridge will simply be folded. The cartridge will then be removed and disposed of

1. What I claim as my invention is a sanitary and functional method of storing and discarding unwanted cooking fats and oil by providing an aesthetically pleasing container with disposable oil reservoirs, uniquely engineered so that the decorative container and disposable oil reservoirs compliment each other in fixation for the execution of said task and being comprised of: a lid funnel system to prevent spillage, a container body with an integrated lip on the inside specifically engineered to hold the oil reservoir and an oil reservoir cylinder bag engineered so as to not fall into the container.
